(19) United States
(12) Patent Application Publication
(10) Pub. No.: US 2011/0157621 A1
(43) Pub. Date: Jun. 30, 2011

(54) SYSTEM AND METHOD FOR PRINTING WEB PAGE

(75) Inventors: HUO-PING FU, Shenzhen City (CN); YI-FANG WU, Tu-Cheng (TW)

(73) Assignees: HONG FU JIN PRECISION INDUSTRY (ShenZhen) CO., LTD ., Shenzhen City (CN); HON HAI PRECISION INDUSTRY CO., LTD., Tu-Cheng (TW)

(21) Appl. No.: 12/728,663

(22) Filed: Mar. 22, 2010

(30) Foreign Application Priority Data
Dec. 31, 2009 (CN) 200910312984.6

(51) Int. Cl. G06F 3/12

(52) U.S. Cl. 358/1.15

(57) ABSTRACT

A system includes a portable electronic device and a web page printing module installed in the portable electronic device. The portable electronic device has an embedded operating system and a web browser for presenting a web page. The web page printing module is capable of converting the web page to a picture format file and then converting the picture format file to a print (PRN) file which is printable by a printer. A printing method associated with above described system is also disclosed.

### BACKGROUND

1. Technical Field

The disclosure generally relates to printing systems and printing methods, more particularly to a system and method capable of printing a web page displayed by a portable electronic device.

2. Description of Related Art

Nowadays, more and more portable electronic devices such as mobile phones, PDAs or the like have web browsers for presenting web pages. Thus, users can conveniently get information they need via the web pages. Often the users will also want to print the web pages being currently viewed. However, the web pages displayed by the portable electronic devices usually cannot be directly sent to printers for printing. One reason is that most of the portable electronic devices do not communicatively connect to printers. Another reason is that the portable electronic devices usually adopt embedded operating systems which are designed to be compact and efficient, but do not provide a print function to print the web pages. The users have to utilize a computer connected to printers for printing the web pages, which is inconvenient.

What is needed, therefore, is a system and method capable of printing a web page displayed by a portable electronic device conveniently.

### BRIEF DESCRIPTION OF THE DRAWINGS

FIG. 1 is a schematic view of a printing system according to an embodiment.

FIG. 2 is a schematic block diagram of a portable electronic device in FIG. 1.

FIG. 3 is a flowchart of a printing method according to an embodiment.

FIG. 4 is a detail flowchart of step S04 in FIG. 3.

FIG. 5 is a detail flowchart of step S05 in FIG. 4.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM.

It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

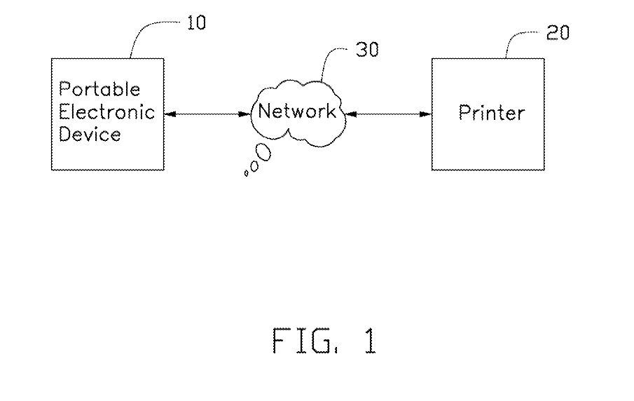

Referring to FIG. 1, a printing system in an embodiment includes a portable electronic device 10 (such as a mobile phone or the like) and a printer 20. The portable electronic device 10 and the printer 20 are communicatively connected to each other in a point-to-point network 30. Thus, the portable electronic device 10 can directly communicate with the printer 20. In the embodiment, the point-to-point network 30 can be a point-to-point Wireless Fidelity (WIFI) network.

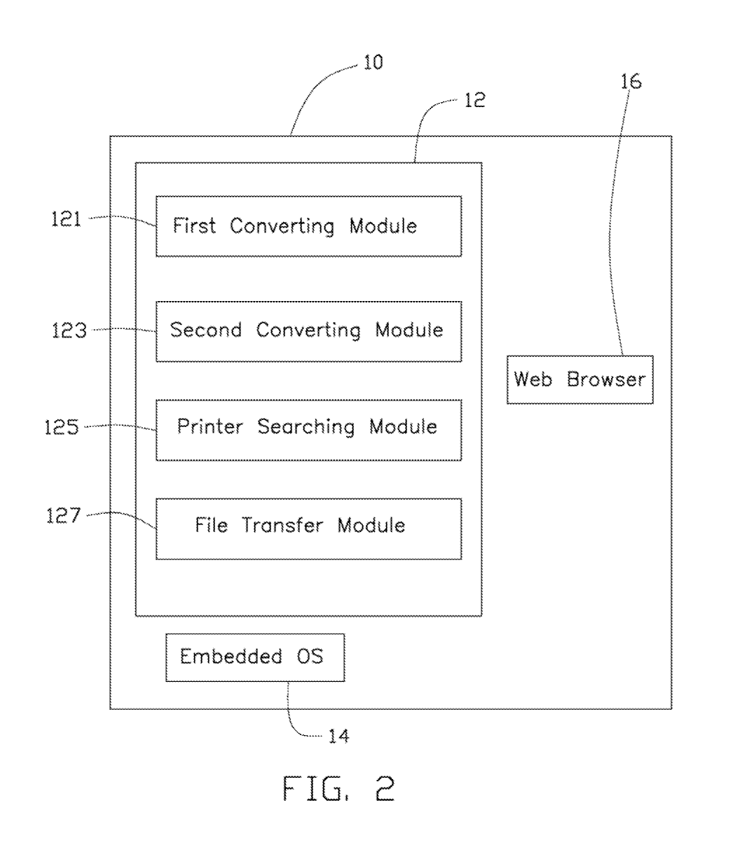

Referring to FIG. 2, the portable electronic device 10 includes a web page printing module 12, an embedded operating system 14 which offers services to application programs and users, and a web browser 16 for presenting a web page on a display of the portable electronic device 10. The web page print module 12 includes a first converting module 121, a second converting module 123, a printer searching module 125, and a file transfer module 127. The first converting module 121 is configured to convert the web page to a picture format file. The second converting module 123 is configured to convert the picture format file to a print (PRN) file with an extension of .prn which the printer 20 can recognize and print.

The portable electronic device 10 further has a program designed to add a print button to a menu displayed together with the web page. Thus, the user can choose and click the print button for printing the web page directly. A detailed printing method for printing the web page is described below.

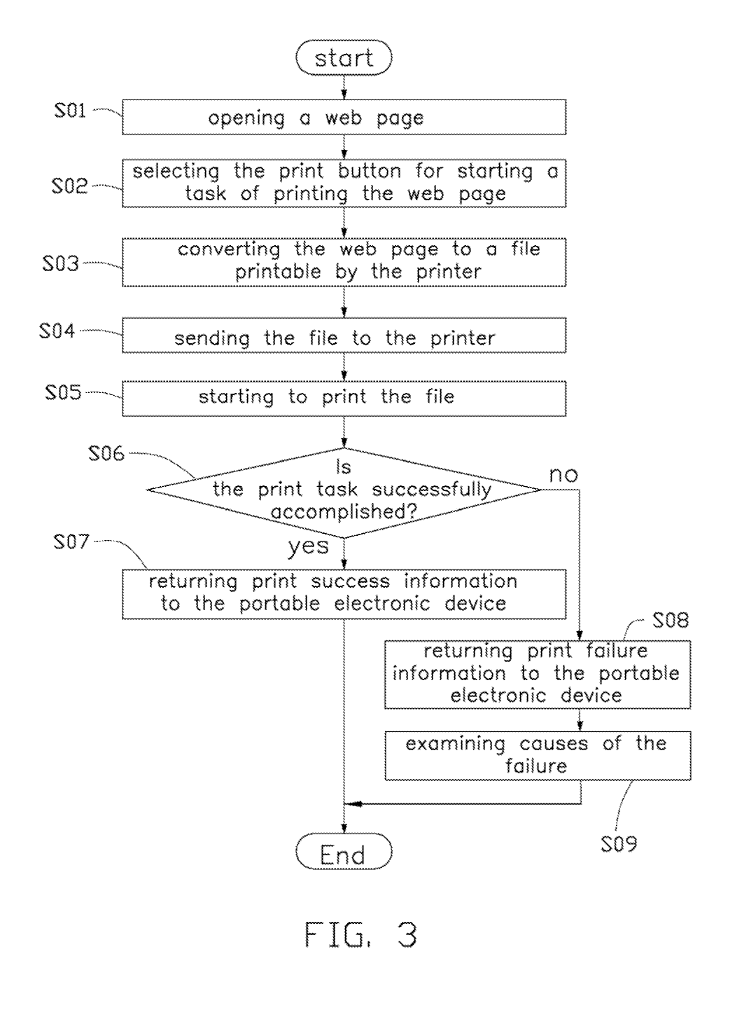

Referring to FIG. 3, a printing method utilizing the above described printing system includes the following blocks.

In block S01, the web browser 16 of the portable electronic device 10 is activated and a web page is opened.

In block S02, a print button displayed by the electronic device 10 with the web page is clicked for printing the web page being currently viewed.

In block S03, the web page is converted to a file capable of being received and printed by the printer 20.

In block S04, the file transfer module 127 of the portable electronic device 10 sends the file to the printer 20.

In block S05, the printer 20 starts printing the file.

In block S06, it is checked if the print task is successfully accomplished.

In block S07, if the print task is successfully accomplished, the printer 20 returns print success information to the portable electronic device 10.

In block S08, if the print task is not successfully accomplished, the printer 20 returns print failure information to the portable electronic device 10.

In block S09, the user examines possible causes of the failure.

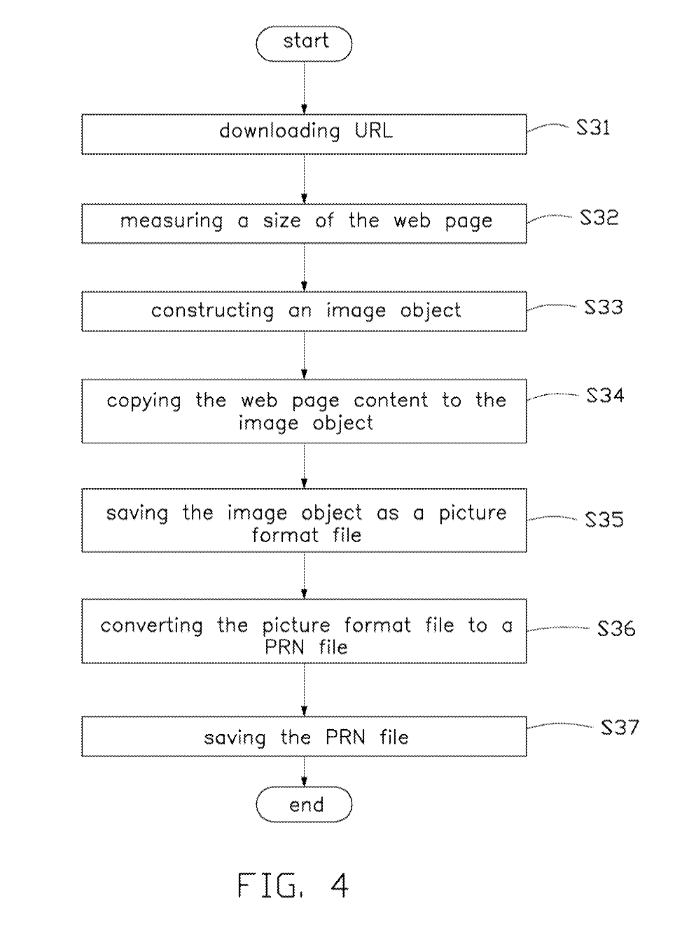

Referring to FIG. 4, the above described block S03 includes following blocks in detail.

In block S31, a Uniform Resource Locator (URL) associated with the web page is downloaded. The URL is configured to specify where an identified resource is available and the mechanism for retrieving it. Utilizing this URL, the web page can be found.

In block S32, a size of the web page is determined.

In block S33, an image object is constructed according to the size of the web page. The image object is substantially the same size as the web page.

In block S34, the web page content is copied and pasted to the image object.

In block S35, the image object is saved as a picture format file.

In block S36, the second converting module 123 converts the picture format file to a PRN file.

In block S37, the PRN file is saved.

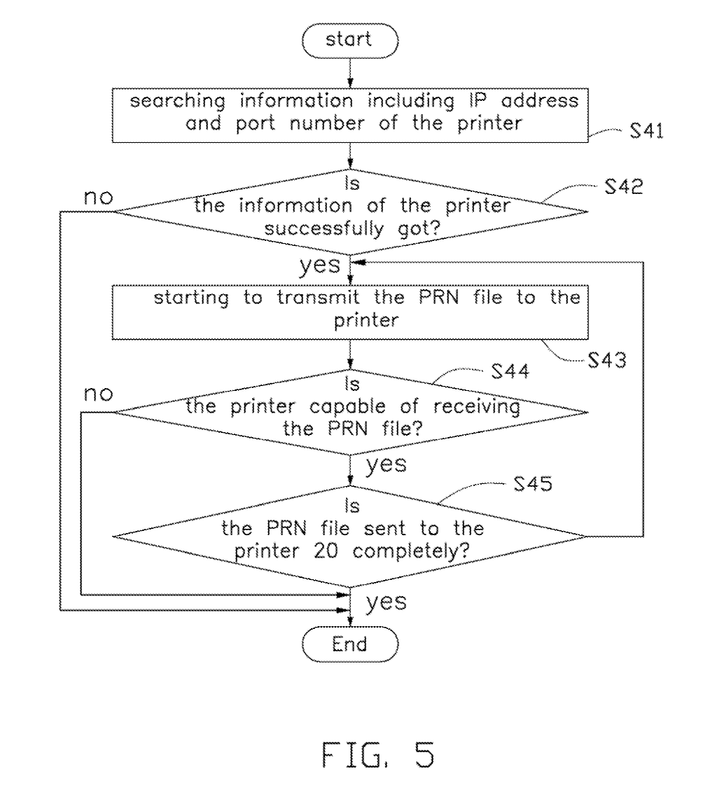

Referring to FIG. 5, the above described block S04 includes following steps in detail.

In block S41, the printer searching module 125 of the electronic device 10 transmits Universal Plug and Play (UPnP) signals to find information including an Internet Protocol (IP) address and a port number of the printer 20. The UPnP data allows seamless and simplified data sharing and communications between the portable electronic device 10 and the printer 20.

In block S42, the web page printing module 12 of the portable electronic device 10 detects if the information of the printer 20 is successfully searched, if yes, go to block S43; if not, the task of printing the web page ends unsuccessfully.

In block S43, the file transfer module 127 of the portable electronic device 10 starts to transmit the PRN file to the printer 20 according to the IP address and port number of the printer 20.

In block S44, the web page printing module 12 of the portable electronic device 10 detects if the printer 20 is capable of receiving the PRN file. If the printer 20 is capable of receiving the PRN file, go to block S45; if not, the task of printing the web page ends unsuccessfully.

In block S45, the web page printing module 12 of the portable electronic device 10 detects if the PRN file is sent to the printer 20 completely. If the PRN file is not yet sent to the printer 20 completely, go back to block S53 to continue sending the PRN file; if the PRN file is sent to the printer 20 completely, the step of sending the PRN is accomplished and successfully ends.

It is to be understood, however, that even though numerous characteristics and advantages have been set forth in the foregoing description of preferred embodiments, together with details of the structures and functions of the preferred embodiments, the disclosure is illustrative only, and changes may be made in detail, especially in matters of shape, size, and arrangement of parts within the principles of the invention to the full extent indicated by the broad general meaning of the terms in which the appended claims are expressed.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. A system comprising:
a portable electronic device comprising an embedded operating system and a web browser for presenting a web page; and
a web page printing module installed in the portable electronic device for printing the web page, the web page printing module capable of converting the web page to a picture format file and then converting the picture format file to a print (PRN) file which is printable by a printer.

2. The system of the claim 1, wherein the web printing module comprises a first convert module capable of converting the web page to the picture format file.

3. The system of the claim 2, wherein the web printing module further comprises a second converting module capable of converting the web page to the PRN file.

4. The system of the claim 3, wherein the web printing module further comprises a printer searching module capable of searching for an Internet Protocol (IP) address and a port number of the printer.

5. The system of the claim 1, wherein the web printing module further comprises a file transfer module capable of transmitting the PRN file.

6. The system of the claim 1, wherein the electronic device is capable of connecting to the printer via a point-to-point Wireless Fidelity (WIFI) network.

7. The system of the claim 1, wherein the portable electronic device is a mobile phone.

8. A printing method comprising:
connecting a portable electronic device to a printer via a point-to-point network;
opening a web browser of the portable electronic device to present a web page;
activating a print button on a menu presented by the portable electronic device;
converting the web page to a picture format file;
converting the picture format file to a print (PRN) file;
sending the PRN file to the printer for printing.

9. The method of claim 8, wherein the step of converting the web page to the picture format file comprises downloading a Uniform Resource Locator (URL) associated with the web page; measuring a size of the web page; constructing an image object having the same size as the web page; and copying the web page to the image object.

10. The method of claim 8, wherein the step of sending the PRN file comprises searching for information, the information includes an Internet Protocol (IP) address and a port number of the printer, and transmitting the PRN file to the printer according to the IP address and the port number until the PRN file is completely sent to the printer.

11. The method of claim 8, further comprising detecting whether the PRN file is successfully printed; if the PRN file is successfully printed, returning print success information to the portable electronic device; if the PRN file is not successfully printed, returning print failure information to the portable electronic device.

12. The method of claim 8, wherein the point-to-point network is a point-to-point WIFI network.
